(19) United States
(12) Patent Application Publication
(10) Pub. No.: US 2021/0158730 A1
(43) Pub. Date: May 27, 2021

(54) INFORMATION PROCESSING APPARATUS, INFORMATION PROCESSING METHOD, AND PROGRAM

(71) Applicant: SONY CORPORATION, TOKYO (JP)

(72) Inventors: MASAO KONDO, KANAGAWA (JP); HIROTAKA TAKO, KANAGAWA (JP); YOSHIYASU KUBOTA, KANAGAWA (JP)

(21) Appl. No.: 17/045,488

(22) PCT Filed: Mar. 4, 2019
(86) PCT No.: PCT/JP2019/008362

§ 371 Date: Oct. 5, 2020

(30) Foreign Application Priority Data
Apr. 13, 2018 (JP) 2018-077762

(51) Int. Cl. G09G 3/00; G06K 9/62; G06K 9/20

(52) U.S. Cl. CPC G09G 3/001; G09G 2354/00; G06K 9/2054; G06K 9/6268

(57) ABSTRACT

An information processing apparatus according to an embodiment of the present technology includes a projection controller and a mode controller. The projection controller controls projection of first information and projection of second information that is classified as information of which a type is different from a type of the first information. The mode controller is capable of performing switching between a first projection mode and a second projection mode, the first projection mode being a projection mode in which the first information and the second information are projected onto a projection-target object, the second projection mode being a projection mode in which the first information is projected onto the projection-target object, and the second information is projected onto a region outside of the projection-target object.

### TECHNICAL FIELD

The present technology relates to an information processing apparatus, an information processing method, and a program that are applicable to control of projection of an image.

### BACKGROUND ART

Conventionally, a projector is widely known as a projection image display apparatus that displays a projected image on a screen. Recently, there has been an increasing demand for a super-wide-angle front-projection projector that is capable of performing a large-screen display even on a small projection space, as disclosed in Patent Literature 1. The use of such a projector makes it possible to perform a large-screen projection onto a limited space by performing an oblique projection at a wide angle with respect to a screen.

### CITATION LIST

### Patent Literature

Patent Literature 1: Japanese Patent No. 5365155

### DISCLOSURE OF INVENTION

### Technical Problem

It is expected that a projection image display apparatus will continue to be widely used, and thus there is a need for a technology that makes it possible to display a high-quality image.

In view of the circumstances described above, it is an object of the present technology to provide an information processing apparatus, an information processing method, and a program that make it possible to display a high-quality image.

### Solution to Problem

In order to achieve the object described above, an information processing apparatus according to an embodiment of the present technology includes a projection controller and a mode controller.

The projection controller controls projection of first information and projection of second information that is classified as information of which a type is different from a type of the first information.

The mode controller is capable of performing switching between a first projection mode and a second projection mode, the first projection mode being a projection mode in which the first information and the second information are projected onto a projection-target object, the second projection mode being a projection mode in which the first information is projected onto the projection-target object, and the second information is projected onto a region outside of the projection-target object.

In the information processing apparatus, it is possible to perform switching between a first projection mode and a second projection mode, the first projection mode being a projection mode in which first information and second information that are classified as different pieces of information are projected onto a projection-target object, the second projection mode being a projection mode in which the first information is projected onto the projection-target object, and the second information is projected onto a region outside of the projection-target object. This makes it possible to display a high-quality image.

When the second projection mode is selected, the projection controller may cause the first information to be projected onto the projection-target object in a largest size corresponding to a size of the projection-target object.

When the second projection mode is selected, the projection controller may cause the second information to be projected onto a position situated within a specified distance from the projection-target object.

The information processing apparatus may further include an acquisition section that acquires target-object information that includes a position of the projection-target object. In this case, the projection controller may control the projection of the first information and the projection of the second information on the basis of the acquired target-object information.

The target-object information may include a shape and a size of the projection-target object.

The acquisition section may acquire the target-object information on the basis of detection information regarding the projection-target object, the detection information being detected by a detection apparatus.

The acquisition section may acquire the target-object information on the basis of setting information regarding the projection-target object, the setting information being set by a user.

The acquisition section may acquire region information regarding a projection-available region that includes a region, in the projection-target object, onto which projection is performed. In this case, the projection controller may control the projection of the first information and the projection of the second information on the basis of the target-object information and the region information.

The projection-target object may be a screen that is arranged on a projection-target surface. In this case, the screen may be made of material that enables the screen to display thereon a projection image with a higher image quality when the projection image is projected onto the screen than when the projection image is projected onto the projection-target surface. Further, when the second projection mode is selected, the projection controller may perform control on the basis of the target-object information and the region information, such that the first information is projected onto the screen in a largest size corresponding to a size of the screen, and such that the second information is projected onto a region that is situated outside of the screen and included in the projection-available region.

The first information may include content information. In this case, the second information may include at least one of additional information related to the content information, menu information, notification information, or advertisement information.

When the second projection mode is selected, the projection controller may be capable of controlling at least one of a position, a shape, or a size of the second information to be projected.

The target-object information may include information regarding a positional change, the information regarding a positional change indicating a change in a relative position of the projection-target object with respect to an image projection apparatus that projects the first information and the second information. In this case, the display controller may control the projection of the first information and the projection of the second information on the basis of the information regarding a positional change.

When the second projection mode is selected, the display controller may control the projection of the first information and the projection of the second information on the basis of the information regarding a positional change such that the projection of the first information and the projection of the second information are respectively maintained, the projection of the first information being projection of the first information onto the projection-target object, the projection of the second information being projection of the second information onto the outside region.

The information processing apparatus may further include a detector that detects presence or absence of the projection-target object. In this case, the mode controller may select the second projection mode when the projection-target object is detected.

When the second projection mode is selected, the projection controller may determine whether the second information is projectable onto a blank region that is a region, in the projection-target object, onto which the first information is not projected, and the projection controller may project the second information onto the blank region when the second information is projectable onto the blank region.

When the second projection mode is selected, the projection controller may determine whether the second information is projectable onto the region outside of the projection-target object, and the projection controller may project the second information onto the projection-target object when the second information is not projectable onto the outside region.

When the second projection mode is selected, the projection controller may control the projection of the second information according to a change in at least one of a position, a shape, or a size of the first information to be projected.

The projection controller may control the projection of the first information and the projection of the second information, the projection of the first information and the projection of the second information being performed by an image projection apparatus.

An information processing method according to an embodiment of the present technology is performed by a computer system, and includes controlling projection of first information and projection of second information that is classified as information of which a type is different from a type of the first information.

Switching between a first projection mode and a second projection mode is performed, the first projection mode being a projection mode in which the first information and the second information are projected onto a projection-target object, the second projection mode being a projection mode in which the first information is projected onto the projection-target object, and the second information is projected onto a region outside of the projection-target object.

A program according to an embodiment of the present technology causes a computer system to perform a process including:

controlling projection of first information and projection of second information that is classified as information of which a type is different from a type of the first information; and

performing switching between a first projection mode and a second projection mode, the first projection mode being a projection mode in which the first information and the second information are projected onto a projection-target object, the second projection mode being a projection mode in which the first information is projected onto the projection-target object, and the second information is projected onto a region outside of the projection-target object.

### Advantageous Effects of Invention

As described above, the present technology makes it possible to display a high-quality image. Note that the effect described here is not necessarily limitative, and any of the effects described in the present disclosure may be provided.

### BRIEF DESCRIPTION OF DRAWINGS

FIG. 1 schematically illustrates an example of a configuration of an image display system according to a first embodiment.

FIG. 2 schematically illustrates an example of the configuration of the image display system according to the first embodiment.

FIG. 3 is a block diagram illustrating an example of a functional configuration of a system control apparatus.

FIG. 4 is a flowchart illustrating an example of an image display performed by the image display system.

FIG. 5 is a flowchart illustrating an example of processing when an image is projected in each projection mode.

FIG. 6 is a schematic diagram for describing an example of setting a parameter regarding a screen.

FIG. 7 schematically illustrates examples of layouts in respective projection modes.

FIG. 8 illustrates an example of a layout when the full-screen display mode is selected.

FIG. 9 illustrates other examples of the layout when the full-screen display mode is selected.

FIG. 10 is a schematic diagram for describing an example of a control of projection of primary information and projection of secondary information when the screen is moved.

FIG. 11 is a schematic diagram for describing another example of the control of the projection of the primary information and the projection of the secondary information according to the positional change in the screen.

FIG. 12 is a flowchart illustrating an example of a control of projection of the primary information and projection of the secondary information according to a second embodiment when the full-screen display mode is selected.

FIG. 13 is a schematic diagram for describing the example of the projection control illustrated in FIG. 12.

FIG. 14 is a flowchart illustrating an example of a control of projection of the primary information and projection of the secondary information according to a third embodiment when the full-screen display mode is selected.

FIG. 15 is a schematic diagram for describing the example of the projection control illustrated in FIG. 14.

FIG. 16 is a schematic diagram for describing an example of detecting the position, the shape, and the size of the screen.

FIG. 17 schematically illustrates another example of the configuration of the screen.

### MODE(S) FOR CARRYING OUT THE INVENTION

Embodiments according to the present technology will now be described below with reference to the drawings.

### First Embodiment

### [Image Display System]

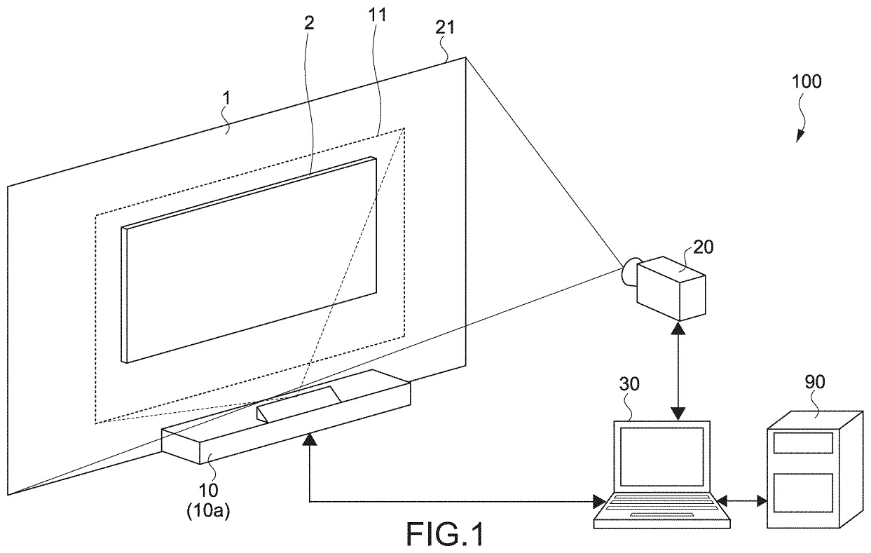

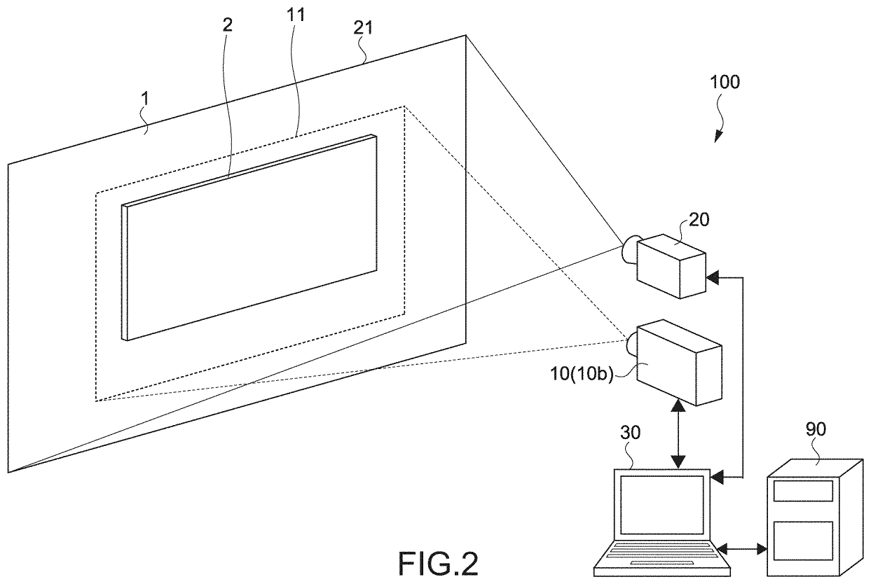

FIGS. 1 and 2 each schematically illustrate an example of a configuration of an image display system according to a first embodiment of the present technology. An image display system 100 includes a projector 10 (10a and 10b), a camera 20, and a system control apparatus 30.

The projector 10 is capable of generating an image to project the image. The projector 10 is set such that the projector 10 is capable of projecting an image onto a projection-target surface 1. In FIG. 1, a short focus projector is used as the projector 10a. In FIG. 2, a long focus projector is used as the projector 10b. The present technology is applicable to a projection image display apparatus having any configuration regardless of the type of the projector 10. An image projected by the projector 10 may be hereinafter referred to as a projection image.

As illustrated in FIGS. 1 and 2, in the present embodiment, a screen 2 is arranged on the projection-target surface 1. The projection-target surface 1 is a surface that serves as a reference for installing the screen 2, and is, for example, a specified wall surface inside a room. The screen 2 has a rectangular shape as viewed from the front, and has an approximate plate shape having a thickness of about 20 mm. A material of the screen 2 is selected as appropriate such that an image projected by the projector 10 is displayed with a higher image quality (such as an image quality in which brightness and contrast of the projection image are higher) when projected onto the screen 2 than when projected onto the projection-target surface 1. Alternatively, the surface of the screen 2 is processed such that a high-quality image is displayed.

The shape (such as an aspect ratio) and the size of the screen 2 are not limited, and any screen 2 may be used. In the present embodiment, the screen 2 corresponds to a projection-target object. Further, a region, in the screen 2, onto which an image is projected corresponds to a projection region of the screen 2.

As illustrated in FIGS. 1 and 2, in the present embodiment, a projection-available region 11 for the projector 10 is set to be larger in size than the screen 2. The aspect ratio of the projection-available region 11 may be set to be equal to or different from the aspect ratio of the screen 2. In the present embodiment, the projector 10 corresponds to an image projection apparatus.

The camera 20 is set to be oriented toward the projection-target surface 1 such that an image-capturing range 21 is larger in size than the projection-available region 11 for the projector 10. The camera 20 is capable of capturing both a still image and a moving image. For example, a digital camera including an image sensor such as a complementary metal-oxide semiconductor (CMOS) sensor or a charge coupled device (CCD) sensor is used as the camera 20. Moreover, any camera may be used.

In the present embodiment, the camera 20 serves as a detection apparatus that is capable of detecting detection information regarding a projection-target object. A captured image that is captured by the camera 20 corresponds to the detection information regarding a target object.

The system control apparatus 30 performs an overall control on the image display system 100. As illustrated in FIGS. 1 and 2, the system control apparatus 30 is communicatively connected to the projector 10 and the camera 20. How the system control apparatus 30 is connected to the respective devices is not limited, and, for example, a wireless LAN communication such as Wi-Fi or Near field communication such as Bluetooth (registered trademark) is used.

As illustrated in FIGS. 1 and 2, the system control apparatus 30 receives image information from an external image supply apparatus 90. Further, the system control apparatus 30 reads image information from a storage medium such as a CD (registered trademark), a DVD (registered trademark), or a Blu-ray Disc (registered trademark). The system control apparatus 30 sets a layout of an image projected onto the projection-target surface 1, and outputs the layout to the projector 10 together with image information. On the basis of an instruction given by the system control apparatus 30, the projector 10 projects an image onto the projection-target surface 1.

The image supply apparatus 90 is, for example, a server installed in a network. The system control apparatus 30 receives image information via the network. The network is built by, for example, the Internet or a wide region communication network. Further, any wide area network (WAN), any local area network (LAN), or the like may be used, and a protocol used to build the network is not limited.

The network may be used to connect the system control apparatus 30 to the projector 10 and to the camera 20. In the present embodiment, the system control apparatus 30 serves as an embodiment of an information processing apparatus according to the present technology.

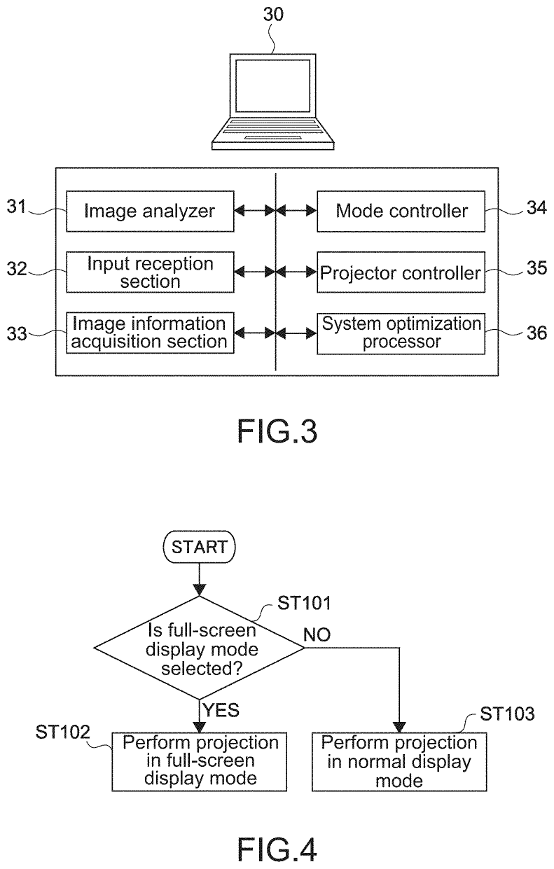

FIG. 3 is a block diagram illustrating an example of a functional configuration of the system control apparatus 30.

The system control apparatus 30 includes hardware, such as a CPU, a ROM, a RAM, and an HDD, that is necessary for a configuration of a computer. Each block illustrated in FIG. 3 is implemented by the CPU loading, into the RAM, a program according to the present technology that has been recorded in the ROM or the like and executing the program, and this results in an information processing method according to the present technology being performed.

The system control apparatus 30 can be implemented by any computer such as a personal computer (PC). Of course, hardware such as an FPGA or an ASIC may be used. In order to implement each block illustrated in FIG. 3, dedicated hardware such as an integrated circuit (IC) may be used.

The program is installed on the system control apparatus 30 through, for example, various recording media. Alternatively, the installation of the program may be performed via, for example, the Internet.

As illustrated in FIG. 3, the system control apparatus 30 includes an image analyzer 31, an input reception section 32, an image information acquisition section 33, a mode controller 34, a projector controller 35, and a system optimization processor 36.

The image analyzer 31 analyzes a captured image that is captured by the camera 20. In the present embodiment, it is possible to detect the position, the shape, and the size of the screen 2 using the image analyzer 31. For example, the position of the screen 2 is calculated using an XYZ coordinate value, with a specified reference point being used as an origin. For example, the XYZ coordinate values of vertexes of four corners of the screen 2 are calculated as the position of the screen 2, with the position of the projector 10 being used as a reference point. Of course, this method is not limitative.

For example, it is possible to detect the shape and the size of the screen 2 using any edge detection technology. For example, an XYZ coordinate value may be calculated for each point on an edge of the screen 2. Further, any image analysis technology may be used to detect the position, the shape, and the size of the screen 2.

The image analyzer 31 is also capable of detecting whether the screen 2 is installed on the projection-target surface 1. In other words, it is possible to detect the presence or absence of the screen 2. For example, it is possible to detect the presence or absence of the screen 2 by capturing an image of the projection-target surface 1 on which the screen 2 is not set and by performing matching or the like using the image. Of course, this method is not limitative.

Any machine-learning algorithm using, for example, a deep neural network (DNN) may be used to detect the position, the shape, and the size of the screen 2 and to detect the presence or absence of the screen 2. For example, it is possible to improve the accuracy in detecting the position, the shape, and the size of the screen 2 and to improve the accuracy in detecting the presence or absence of the screen 2, using, for example, artificial intelligence (AI) that performs deep learning.

Note that machine learning or the like may be used to perform other processing described in the present disclosure, such as processing performed by the system optimization processor 36 or the like. This makes it possible to improve the accuracy in performing various processes related to image display.

The input reception section 32 receives various inputs performed by a user with respect to the system control apparatus 30. In the present embodiment, the system control apparatus 30 is provided with an operation section such as a keyboard, a mouse, and a touch panel. The input reception section 32 receives an input performed by the user, on the basis of an operation performed on the operation section.

Further, the input reception section 32 is capable of receiving an input performed by a user, on the basis of an operation performed on the projector 10 or the camera 20. Specifically, an operation signal corresponding to an operation performed on the projector 10 or the camera 20 is transmitted to the system control apparatus 30. The input reception section 32 receives an input performed by the user, on the basis of the operation signal transmitted by the projector 10 or the camera 20.

In the present embodiment, various parameters related to the screen 2 installed on the projection-target surface 1 can be set and input by a user. For example, the position, the shape, and the size of the screen 2 are set and input by a user. Setting information regarding the screen 2 is generated by being set by the user, and is received by the input reception section 32.

The image information acquisition section 33 acquires image information regarding an image projected by the projector 10. As described above, for example, the image information acquisition section 33 receives the image information transmitted by the external image supply apparatus 90. Further, the image information acquisition section 33 reads the image information from a recording medium that is set in a drive apparatus (of which an illustration is omitted) of the system control apparatus 30.

In the present embodiment, images projected by the projector 10 are classified into an image of primary information and an image of secondary information classified as information different from the primary information. The primary information is, for example, information (main content) that is a primary viewing target of a user. The secondary information is, for example, information (sub content) that is referred to by the user as appropriate.

Classifying pieces of information into primary information and secondary information means the same as classifying images into an image of the primary information and an image of the secondary information. For example, it is possible to classify pieces of information into primary information and secondary information on the basis of, for example, meta information that is included in or added to image information acquired by the image information acquisition section 33. Of course, this method is not limitative, and any other method may be used.

In the present disclosure, the projection of an image of primary information corresponds to projection of the primary information. The projection of an image of secondary information corresponds to projection of the secondary information. Further, the position, the shape, the size, and the like of an image of primary information that is projected onto the screen 2 or the like respectively correspond to the position, the shape, the size, and the like of the primary information projected onto the screen 2 or the like. Likewise, the position, the shape, the size, and the like of a projected image of secondary information respectively correspond to the position, the shape, the size, and the like of the projected secondary information.

The primary information includes various pieces of content information such as video content. For example, various pieces of video content such as music live, sports, movies, and news are projected as the primary information. Further, photographic content, content (timeline) of a social networking service (SNS), and the like are projected as the primary information.

The secondary information includes additional information regarding video content. For example, subtitles, information regarding a cast member, information regarding a production, and the like are projected as the secondary information.

Further, the secondary information includes menu information. The menu information is, for example, information displayed when an operation input is performed by a user, and a selection image including, for example, an option, a setting image used to set, for example, a parameter, and the like are projected as the secondary information. For example, a GUI or the like used to adjust a channel, the volume, the brightness, the chromaticity, and the like is projected as the secondary information (an image of the secondary information). Note that a channel name can also be called additional information regarding video content.

Furthermore, the secondary information includes various pieces of notification information for a user. For example, an icon or the like used to notify a user of reception of, for example, a mail, an incoming call, and the like is projected as the secondary information. Further, notification information regarding an SNS, and the like are projected as the secondary information. Moreover, the secondary information includes various types of pieces of advertisement information.

The method for classifying pieces of information into primary information and secondary information is not limited. In other words, which information is used as primary information and which information is used as secondary information may be set discretionarily. In the present embodiment, the primary information corresponds to first information. The secondary information corresponds to second information classified as information different from the first information.

Note that the primary information and the secondary information are an embodiment of the first information and the second information according to the present technology. The present technology is not limited to this, and the present technology is applicable to any pieces of information classified as different types of pieces of information, the pieces of information classified as different types of pieces of information corresponding to an embodiment of the first information and the second information according to the present technology.

The mode controller 34 is capable of performing switching between a normal display mode and a full-screen display mode that are projection modes for an image of the projector 10. The normal display mode is a projection mode in which primary information and secondary information are projected onto the screen 2. The full-screen display mode is a projection mode in which the primary information is projected onto the screen 2 and the secondary information is projected onto a region outside of the screen 2.

In other words, in the present disclosure, the normal display means that primary information and secondary information are projected to be displayed on the screen 2. The full-screen display means that the primary information is projected to be displayed on the screen 2, and secondary information is projected to be displayed on a region outside of the screen 2.

In the present embodiment, the normal display mode corresponds to a first projection mode in which the first information and the second information are projected onto a projection-target object. The full-screen display mode corresponds to a second projection mode in which the first information is projected onto the projection-target object and the second information is projected onto a region outside of the projection-target object.

The projector controller 35 controls projection of an image that is performed by the projector 10. The position and the size of the projection-available region for the projector 10, the projection position of the image, and the like are controlled by the projector controller 35 as appropriate.

The system optimization processor 36 performs an overall control such that the image display system 100 performs an optimal operation. For example, the system optimization processor 36 sets a layout of an image projected by the projector 10, and performs rendering. Then, the system optimization processor 36 outputs various instructions regarding image projection to the projector controller 35 such that the image laid out on the projection-target surface 1 is properly projected to be displayed. Further, an operation of each block illustrated in FIG. 3 is controlled by the system optimization processor 36.

In the present embodiment, a projection controller that controls the first information and the second information is implemented by the projector controller 35 and the system optimization processor 36, the second information being classified as information of which a type is different from a type of the first information. Further, the projector controller 35 also serves as an acquisition section that acquires region information regarding the projection-available region 11.

Further, a mode controller that is capable of performing switching between a first projection mode and a second projection mode is implemented by the mode controller 34, the first projection mode being a projection mode in which the first information and the second information are projected onto a projection-target object, the second projection mode being a projection mode in which the first information is projected onto the projection-target object and the second information is projected onto a region outside of the projection-target object.

Further, an acquisition section that acquires target-object information that includes the position of a projection-target object is implemented by the image analyzer 31 and the input reception section 32. Furthermore, the image analyzer 31 also serves as a detector that detects the presence or absence of the projection-target object. Moreover, the respective blocks can also perform various processes as the projection controller, the mode controller, the acquisition section, and the detector, by working cooperatively as appropriate.

[Image Display Performed by Image Display System]

FIG. 4 is a flowchart illustrating an example of an image display performed by the image display system 100. In order to project and display an image on the projection-target surface 1, first, the projection mode is determined by the system optimization processor 36. In the present embodiment, it is determined whether a full-screen display mode is selected by the mode controller 34 (Step 101).

The projection mode is selected by the mode controller 34 on the basis of, for example, input performed by a user. For example, the user performs an input that indicates a selection of one of the full-screen display mode and a normal display mode. The mode controller 34 selects one of the full-screen display mode and the normal display mode on the basis of the input performed by the user.

Alternatively, the projection mode may be automatically selected by the mode controller 34. For example, it is assumed that the screen 2 not having existed on the projection-target surface 1 so far is newly detected by the image analyzer 31. When the screen 2 is newly detected, the full-screen display mode is automatically selected by the mode controller 34. This makes it possible to automatically perform a full-screen display according to the installation of the screen 2, and thus to provide a comfortable viewing experience. This results in displaying a high-quality image.

When the full-screen display mode is selected (YES in Step 101), an image is projected in the full-screen display mode (Step 102). When the full-screen display mode is not selected, that is, when the normal display mode is selected (NO in Step 101), an image is projected in the normal display mode (Step 103).

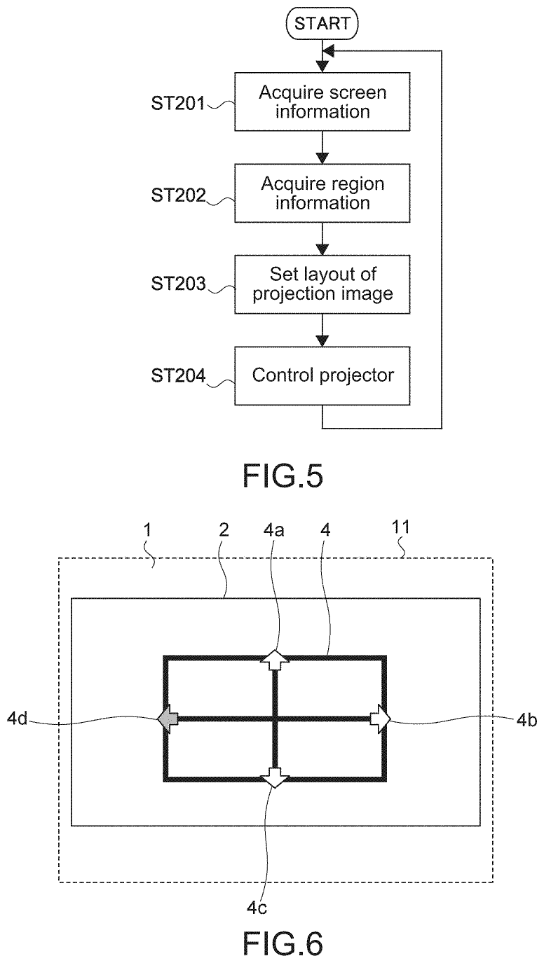

FIG. 5 is a flowchart illustrating an example of processing when an image is projected in each projection mode. The processing illustrated in FIG. 5 is also performed when one of the full-screen display mode or the normal display mode is selected.

First, screen information is acquired (Step 201). The screen information is information regarding the screen 2, and includes the position, the shape, and the size of the screen 2.

In the present embodiment, the screen information corresponds to target-object information regarding a projection-target object. Note that the present technology is applicable to information including at least the position of the screen 2, the information including at least the position of the screen 2 corresponding to the screen information.

In the present embodiment, it is possible to calculate, using the image analyzer 31, screen information on the basis of a captured image captured by the camera 20 (detection information). Further, in the present embodiment, it is also possible to calculate, using the input reception section 32, screen information on the basis of setting information regarding the screen 2 that is set by a user. The calculated screen information is output to the system optimization processor 36.

Note that it may be possible to only perform one of the calculation of screen information that is performed by the image analyzer 31 and the calculation of the screen information that is performed by the input reception section 32.

FIG. 6 is a schematic diagram for describing an example in which a parameter regarding a screen is set by a user. A GUI used to select whether to perform a setting regarding a screen is displayed on the projection-target surface 1, for example, when the image display system 100 is used for the first time, or when the screen 2 is set for the first time, or when screen information has not been acquired.

When an input that indicates that the setting regarding a screen is to be performed, is performed by the user, an option used to select the shape of the screen 2 is displayed. For example, when a rectangular shape is selected by the user, a rectangular setting guide 4 is displayed on the projection-target surface 1, as illustrated in FIG. 6. The user deforms the displayed rectangular setting guide 4 such that the setting guide 4 is superimposed on the edge of the screen 2.

For example, when arrow marks 4a to 4d respectively displayed on an upper side portion, a right side portion, a lower side portion, and a left side portion of the setting guide 4 are selected, colors of the selected arrow marks 4a to 4d are changed. Then, the side portions on which the selected arrow marks 4a to 4d are displayed are moved by operating, for example, a mouse, a D-pad, or the like. It is possible to superimpose the setting guide 4 on the edge of the screen 2 by respectively moving the upper side portion, the right side portion, the lower side portion, and the left side portion of the setting guide 4.

An “Enter” button or the like is selected after the setting guide 4 is superimposed on the edge of the screen 2. The position, the shape, and the size of the setting guide 4 are calculated as setting information, and screen information is calculated on the basis of the setting information. For example, the position, the shape, and the size of the setting guide 4 may be used as the screen information without any change. The position, the shape, and the size of the setting guide 4 are set such that it is possible to calculate the position, the shape, and the size of the setting guide 4 as appropriate on the basis of, for example, the position of the projector 10.

The method of setting of a parameter regarding the screen 2 that is performed by a user is not limited, and any method may be adopted. Any GUI used to set a parameter may be displayed, and a parameter may be set by performing any operation or the like. Further, output of a voice guidance or input of a voice of a user may be used to set a parameter.

Region information regarding the projection-available region 11 for the projector 10 is acquired (Step 202). In the present embodiment, coordinate information indicating a current projection-available region 11 is calculated as the region information by the projector controller 35. For example, XYZ coordinate values of vertexes of four corners of the projection-available region 11 are calculated as the region information. Alternatively, a coordinate value for each point on an edge of the projection-available region 11 may be calculated. Further, any information that makes it possible to specify the projection-available region 11 may be calculated as the region information.

The screen information and the region information respectively acquired in Steps 201 and 202 may be stored as history information in a storage that includes, for example, a ROM or an HDD of the system control apparatus 30. Then, previous history information may be referred to as appropriate when current screen information and current region information are calculated. This makes it possible to display an image on the basis of a change in the screen information and the region information.

A layout of an image projected by the projector 10 is set by the system optimization processor 36, and rendering is performed (Step 203). In the present embodiment, a layout of primary information and secondary information that corresponds to each of the full-screen display mode and the normal display mode is set on the basis of the screen information and the region information respectively acquired in Steps 201 and 202.

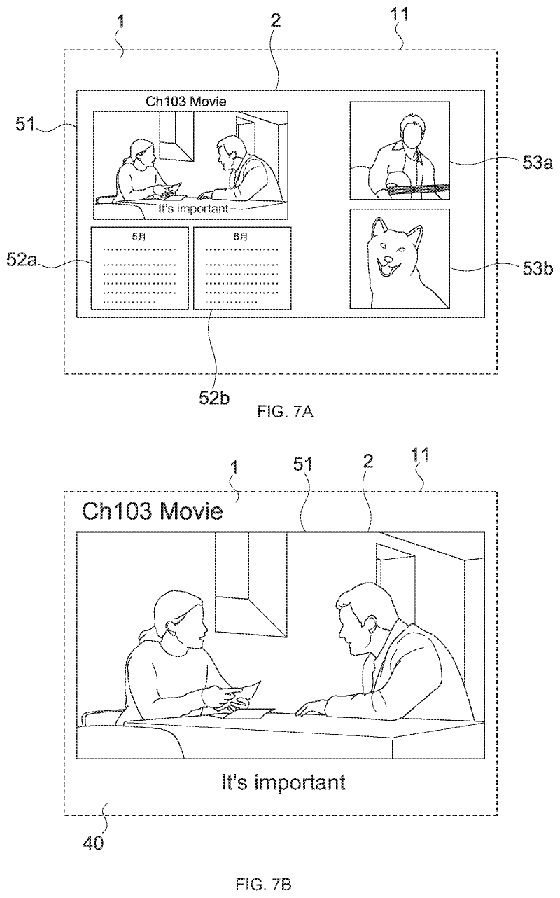

FIG. 7 schematically illustrates examples of layouts in the respective projection modes. A of FIG. 7 illustrates the example of the layout when the normal display mode is selected. B of FIG. 7 illustrates the example of the layout when the full-screen display mode is selected.

The normal display mode is a mode in which primary information and secondary information are projected onto the screen 2 and displayed together on the screen 2. In the example illustrate in A of FIG. 7, the layout is set such that a plurality of pieces of primary information that is video content 51, calendars 52a and 52b, and pieces of photographic content 53a and 53b is displayed on the screen 2. Further, the layout is set such that a plurality of pieces of secondary information that is a subtitle (“It's important”), a channel number (“103”), and a channel name (“Movie”) of the video content 51 is displayed on the screen 2.

Note that, from among the plurality of pieces of secondary information, the subtitle is laid out to be superimposed on the video content 51 that is the primary information. On the other hand, the channel number and the channel name are laid out to be displayed on a region outside of the video content 51 in the screen 2. As illustrated in A of FIG. 7, it is possible to enjoy a plurality of pieces of content at the same time in the normal display mode.

The full-screen display mode is a projection mode in which primary information is projected onto the screen 2, and secondary information is projected onto a region 40 outside of the screen 2. The region 40 outside of the screen 2 is a region situated outside of the screen 2 in the projection-available region 11.

In the example illustrated in B of FIG. 7, the layout is set such that the video content 51 that is the primary information is displayed on the screen 2. Note that the layout is set such that the video content 51 is displayed in a largest size corresponding to the size of the screen 2.

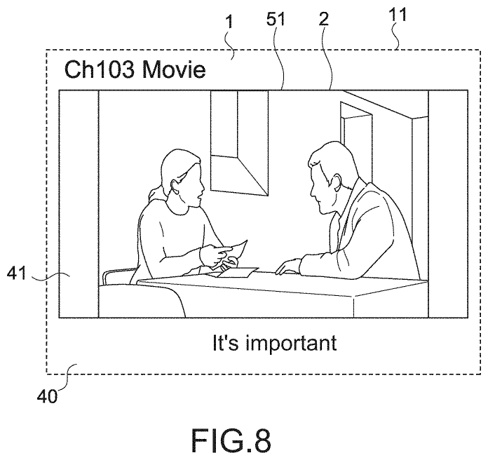

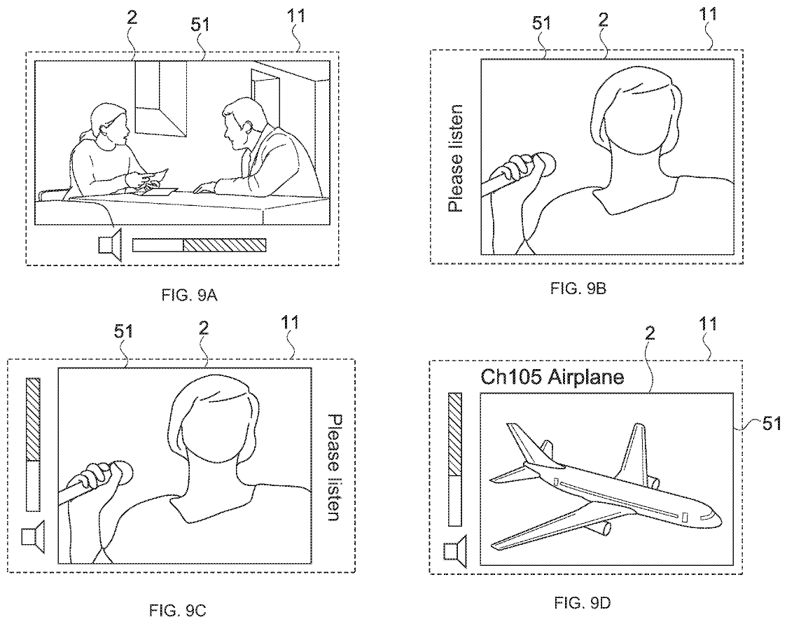

Note that the display of primary information in a largest size includes displaying primary information using the entire screen 2, as illustrated in B of FIG. 7. The display of primary information in a largest size is not limited to this, and includes displaying primary information having a specified aspect ratio in a largest size, with the specified aspect ratio being maintained, as illustrated in FIG. 8. Therefore, as illustrated in FIG. 8, a blank region 41 that is a region in which primary information is not displayed on the screen 2, may exist even when the primary information is displayed in a largest size.

In the examples illustrated in B of FIG. 7 and FIG. 8, the layouts are set such that the plurality of pieces of secondary information that is the subtitle (“It's important”), the channel number (“103”), and the channel name (“Movie”) of video content 51 is displayed on the region 40 outside of the screen 2.

From among the plurality of pieces of secondary information, the subtitle is laid out to be displayed on a region below the screen 2. On the other hand, the channel number and the channel name are laid out to be displayed on a region above the screen 2. Further, the layout of the plurality of pieces of secondary information is set such that the plurality of pieces of secondary information is displayed on positions each situated within a specified distance from the screen 2.

The specified distance is set by, for example, a fixed value, with the center of the screen 2 or the periphery of the screen 2 being used as a reference. Alternatively, the specified distance may be set as appropriate by the system optimization processor 36 according to the size of the screen 2. Moreover, the method for setting the specified distance is not limited. The specified distance is typically set such that secondary information is displayed near the screen 2. Consequently, in the full-screen display mode, video content that a user wants to visually recognize with a high image quality, is displayed in a large size on a projection region of the screen 2, in which the video content can be projected onto the screen 2 with a higher image quality than onto the projection-target surface 1. Further, secondary information is displayed within a specified distance from the large display. In other words, the secondary information is displayed at a position that is situated within a specified distance from the high-quality large display and at which it is intuitively easy to visually recognize the high-quality large display, and this results in being able to provide a comfortable video experience for a user.

For example, the size of the projection-available region 11 is defined according to the size and the resolution of primary information displayed on the screen 2. The position, the shape, the size, the resolution, and the like of secondary information are controlled as appropriate such that the secondary information is displayed on the region 40 outside of the screen 2 in the projection-available region 11 of which the size is defined. It is also possible to carry out the present technology by adopting a configuration in which at least one of the position, the shape, or the size of the secondary information is controllable. Moreover, the method for laying out the secondary information is not limited, and any method may be adopted.

FIG. 9 schematically illustrates other examples of the layout when the full-screen display mode is selected. In the examples illustrated in A to D of FIG. 9, the layouts are each set such that the video content 51 is displayed in a largest size using the entire screen 2.

In the example illustrated in A of FIG. 9, the layout is set such that a volume bar that is a GUI used to adjust volume is displayed near a lower portion of the screen 2 (on a position situated within a specified distance from the screen 2). In the example illustrated in B of FIG. 9, the layout is set such that a subtitle (Please listen) of the video content 51 is displayed near a left portion of the screen 2.

In the example illustrated in C of FIG. 9, the layout is set such that the subtitle (Please listen) of the video content 51 is displayed near a right portion of the screen 2. Further, the layout is set such that a volume bar used to adjust volume is displayed near the left portion of the screen 2.

In D of FIG. 9, the layout is set such that a channel number (“105”) and a channel name (“Airplane”) of the video content 51 are displayed near an upper portion of the screen 2. Further, the layout is set such that a volume bar used to adjust volume is displayed near the left portion of the screen 2.

As illustrated in A to D of FIG. 9, the position of secondary information may be set discretionarily in the region 40 outside of the screen 2 in the projection-available region 11.

The system optimization processor 36 generates an image signal (image information) of an image in a set layout on the basis of image information acquired by the image information acquisition section 33. The method for generating an image signal is not limited, and any image processing technology may be used.

The projector 10 is controlled by the projector controller 35 such that primary information and secondary information are displayed in a set layout (Step 204). The projector controller 35 outputs, to the projector 10, the image signal generated by the system optimization processor 36. Then, the projector controller 35 causes the primary information to be projected onto the screen 2 by the projector 10, and causes the secondary information to be projected onto the region 40 outside of the screen 2 by the projector 10. This results in displaying the primary information and the secondary information in the layouts illustrated in B of FIG. 7 or the layouts illustrated in FIG. 9.

In other words, in the present embodiment, projection of primary information and projection of secondary information are controlled on the basis of the screen information and the region information respectively acquired in Steps 201 and 202. Further, when the full-screen display mode is selected, the primary information is projected onto the screen 2 in a largest size. Furthermore, when the full-screen display mode is selected, the secondary information is projected near the screen 2. Moreover, when the full-screen display mode is selected, at least one of the position, the shape, or the size of the projected secondary information is controlled.

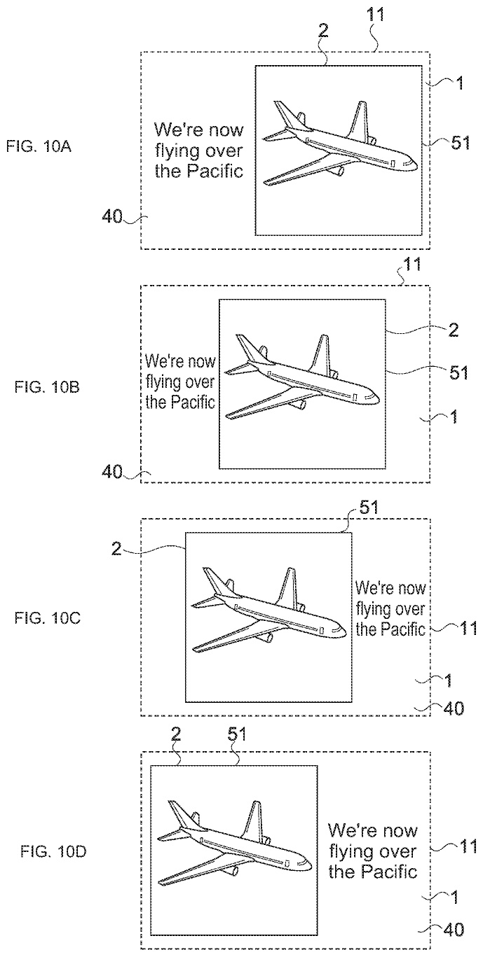

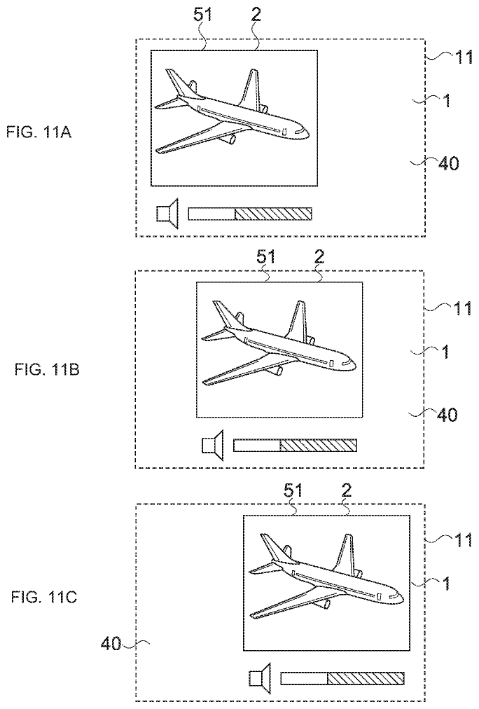

FIG. 10 is a schematic diagram for describing an example of a control of projection of primary information and projection of secondary information when the screen 2 is moved. For example, the screen 2 may be moved in the projection-target surface 1 by, for example, an instruction given by a user. In the present embodiment, it is possible to detect information regarding a positional change as screen information using the image analyzer 31, the information regarding a positional change indicating a change in a relative position of the screen 2 with respect to the projector 10.

The system optimization processor 36 controls the projection of primary information and the projection of secondary information on the basis of the detected information regarding a positional change in the screen 2. For example, when the full-screen display mode is selected, the projection of the primary information and the projection of the secondary information are controlled on the basis of the information regarding a positional change, such that the projection of the primary information and the projection of the secondary information are respectively maintained, the projection of the primary information being projection of the primary information onto the screen 2, the projection of the secondary information being projection of the secondary information onto the region 40 outside of the screen 2.

Specifically, a layout of the primary information and the secondary information that is set as appropriate by the system optimization processor 36 according to the information regarding a positional change in the screen 2. Then, by the projector 10 being controlled by the projector controller 35, the primary information and the secondary information are projected to be displayed in the layout set according to the positional change in the screen 2.

In other words, the flow illustrated in FIG. 5 is repeatedly performed in a specified cycle. This makes it possible to properly project primary information and secondary information according to a positional change in the screen 2. For example, it is possible to perform a projection control such that secondary information is displayed according to the movement of the screen 2, while the position, the shape, and the size of the secondary information are being dynamically changed in order for the secondary information to avoid the screen 2 in real time. Note that the specific length of the specified cycle is not limited, and may be set discretionarily. For example, the cycle may be set on the basis of, for example, a frame rate of the video content 51.

In the example illustrated in A of FIG. 10, a subtitle of the video content 51 (“We're now flying over the Pacific”) is displayed on the outside region 40 situated on the left side of the screen 2, in which the video content 51 is displayed on the entire screen 2. It is assumed that the screen 2 is moved to the left from this state.

As illustrated in B of FIG. 10, the size of the subtitle (the size of the second information) is changed to be smaller according to the movement of the screen 2 to the left. The size of the subtitle is set as appropriate according to, for example, the size of the outside region 40 situated on the left side of the screen 2.

It is assumed that the screen 2 is further moved to the left. As illustrated in C of FIG. 10, the display position of the subtitle (the position of the second information) is changed to a position in the outside region 40 situated on the right side of the screen 2. The size of the subtitle is set such that it is possible to properly display the subtitle on the outside region 40 situated on the right side of the screen 2.

It is assumed that the screen 2 is further moved to the left. As illustrated in D of FIG. 10, the size of the subtitle displayed on the outside region 40 situated on the right side of the screen 2 is changed to be larger. As illustrated in A to D of FIG. 10, a proper image is displayed according to a positional change in the screen 2 by controlling projection of primary information and projection of secondary information. This makes it possible to provide a comfortable viewing experience, and thus a high-quality image is displayed.

FIG. 11 is a schematic diagram for describing another example of the control of the projection of the primary information and the projection of the secondary information according to the positional change in the screen 2. In the examples illustrated in A to C of FIG. 11, the screen 2 is moved to the right, in which the video content 51 is displayed on the entire screen 2.

According to the movement of the screen 2 to the right, a volume bar used to adjust volume is moved to the right to be displayed on the outside region 40 situated on the lower side of the screen 2. In other words, in the examples illustrated in A to C of FIG. 11, the position of the secondary information is moved such that a positional relationship of the secondary information with the screen 2 is maintained according to a positional change in the screen 2. This makes it possible to keep on displaying secondary information near the screen 2, and thus to provide a comfortable viewing experience.

Note that, even when the normal projection mode is selected, it is also possible to properly control the projection of the primary information and the projection of the secondary information on the basis of information regarding a positional change in the screen 2, such that the projection of the primary information and the projection of the secondary information are respectively maintained, the projection of the primary information being projection of the primary information onto the screen 2, the projection of the secondary information being projection of the secondary information onto the screen 2.

It is also possible to properly control the projection of the primary information and the projection of the secondary information in each projection mode not only when the screen 2 is moved, but also when the projector 10 is moved or when the screen 2 and the projector are both moved.

For example, when it is possible to acquire information regarding a position of the projector 10 using the image analyzer 31, it is possible to detect information regarding a change in a relative position of the screen 2 with respect to the projector 10 depending on the movement of the projector 10. Alternatively, the information regarding a position of the projector 10 may be detectable by the projector 10 itself. In this case, it is also possible to detect the information regarding a change in a relative position of the screen 2 with respect to the projector 10 depending on the movement of the projector 10.

It is possible to perform a projection control on the basis of the detected information regarding the positional change, such that the full-screen display mode is properly maintained, for example, as illustrated in FIGS. 10 and 11. Likewise, it is possible to perform a projection control such that the normal display mode is maintained.

As described above, in the image display system 100 according to the present embodiment, it is possible to perform switching between the normal display mode and the full-screen display mode, the normal display mode being a mode in which primary information and secondary information that are classified as different pieces of information are projected onto the screen 2, the full-screen display mode being a mode in which the primary information is projected onto the screen 2, and the secondary information is projected onto the region 40 outside of the screen 2. This makes it possible to display a high-quality image.

For example, there is a problem in which there is a decrease in the visibility of the viewing content due to information such as subtitles and a volume display being superimposed on viewing content to be displayed. Further, it is often the case that information such as subtitles is displayed across a boundary between a dedicated screen and a region outside of the screen when the screen is arranged on a projection-target surface and when a positional relationship between viewing content and the information such as subtitles is fixed. This is responsible for a decrease in the visibility of the viewing content.

In the image display system 100 according to the present embodiment, it is possible to grasp the position, the size, and the shape of the screen 2, and to properly perform a full-screen display in which primary information is displayed on the screen 2 and secondary information is displayed on the region 40 outside of the screen 2.

This makes it possible to project primary information such as content information onto the dedicated screen 2 in priority to secondary information such as subtitles, the primary information requiring a high image quality, the secondary information not strongly requiring a high image quality. This results in being able to view the primary information in a largest size with a very high image quality. Further, it is also possible to provide a greater sense of immersion into content, and thus to provide a comfortable viewing experience.

Further, since display of primary information is not disturbed by secondary information such as subtitles, and the secondary information is not displayed on a boundary between the screen 2 and the outside region 40, a very high visibility is provided with respect to both the primary information and the secondary information.

### Second Embodiment

An image display system according to a second embodiment of the present technology is described. In the following description, descriptions of a configuration and an operation similar to those of the image display system 100 described in the embodiment above are omitted or simplified.

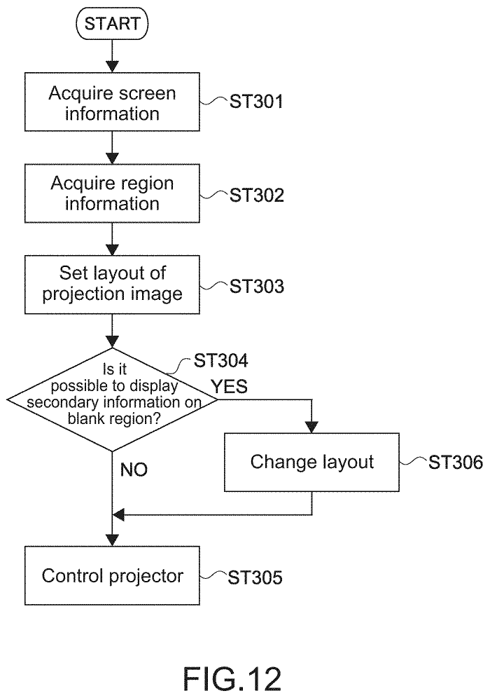

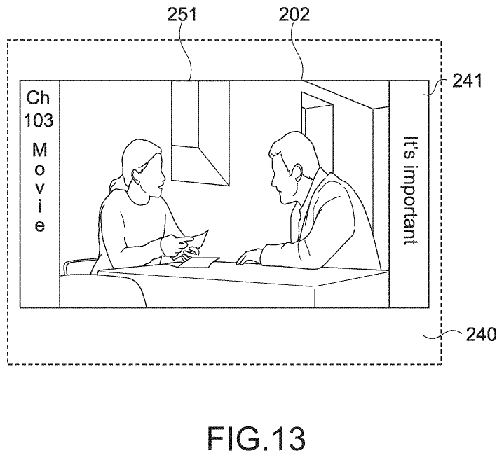

FIG. 12 is a flowchart illustrating an example of a control of projection of primary information and projection of secondary information when the full-screen display mode is selected. FIG. 13 is a schematic diagram for describing the example of the projection control illustrated in FIG. 12.

Steps 301 to 303 illustrated in FIG. 12 are substantially similar to Steps 201 to 203 illustrated in FIG. 5 described in the first embodiment.

In the present embodiment, it is determined, after the layout is set in Step 303, whether it is possible to project the secondary information onto a blank region 241 that is a region, in a screen 202, on which the primary information is not displayed (Step 304). When it is not possible to display the secondary information on the blank region 241 (NO in Step 304), the projector is controlled on the basis of the layout set in Step 303 (Step 305).

When it is possible to display the secondary information on the blank region 241 (YES in Step 304), the layout is changed (Step 306). Specifically, the layout is changed such that it is possible to display the secondary information on the blank region 241. Then, the projector is controlled on the basis of the changed layout (Step 306). This results in projecting the secondary information onto the blank region 241 of the screen 202.

For example, as illustrated in FIG. 13, video content 251 is displayed on the screen 202 such that the video content 251 has a largest size with an aspect ratio being maintained. The blank region 241 that is a region onto which the video content 251 is not projected, exists on each of the left side and the right side of the video content 251 displayed on the screen 202.

In the example illustrated in FIG. 13, the layout is changed such that a channel number (“103”) and a channel name (“Movie”) are displayed on the blank region 241 on the left side. Further, the layout is changed such that a subtitle (“It's important”) of the video content 251 is displayed on the blank region 241 on the right side. As described above, when the full-screen display mode is selected and when there exists a sufficient blank region 241 on the screen 202, secondary information may be projected onto the blank region 241. This makes it possible to display the secondary information with a high image quality, and thus to display a high-quality image.

Note that whether to display secondary information on the region 240 outside of the screen 202 or to display the secondary information on the blank region 241 of the screen 202, may be selected. For example, the display position of the secondary information is set as appropriate according to, for example, input performed by a user.

### Third Embodiment

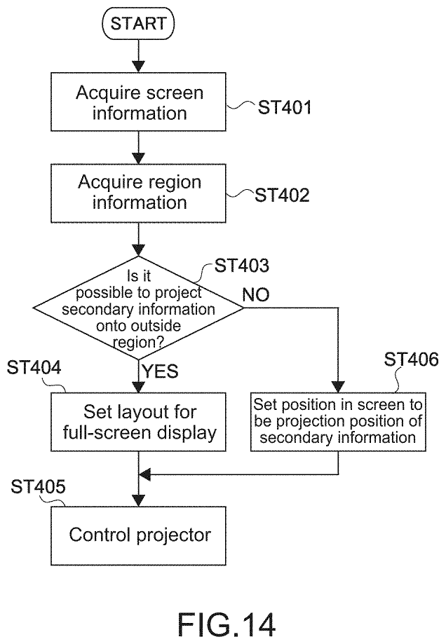

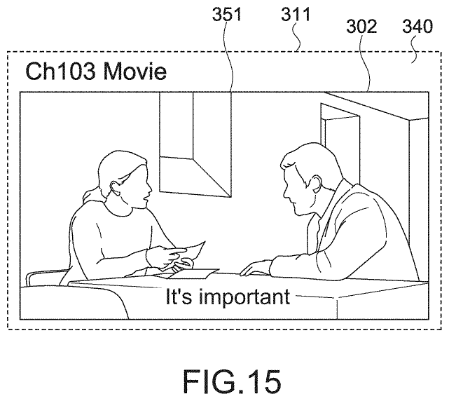

FIG. 14 is a flowchart illustrating an example of a control of projection of primary information and projection of secondary information according to a third embodiment when the full-screen display mode is selected. FIG. 15 is a schematic diagram for describing the example of the projection control illustrated in FIG. 14.

Steps 401 and 402 illustrated in FIG. 14 are substantially similar to Steps 201 and 202 illustrated in FIG. 5 described in the first embodiment.

In the present embodiment, it is determined, upon setting the layout of a projection image, whether it is possible to project secondary information onto a region 340 outside of a screen 302. In other words, it is determined whether a full-screen display is possible (Step 403). This determination is performed on the basis of, for example, the size of the region 340 outside of the screen 302 in a projection-available region 311.

When there exists no outside region 340, or when it is not possible to secure a sufficient size of the outside region 340, it is determined that it is not possible to project the secondary information onto the region 340 outside of the screen 302. Further, when a plurality of pieces of secondary information is projected and when display of all of the plurality of pieces of secondary information on the outside region 340 results in a great difficulty in viewing, it is also determined that it is not possible to project the secondary information onto the outside region 340. Further, criteria for determination may be set discretionarily.

When it is possible to project the secondary information onto the screen 302 (YES in Step 403), a layout used to perform a full-screen display is set (Step 404). The projector is controlled on the basis of the set layout for a full-screen display (Step 406).

When it is not possible to project the secondary information onto the screen 302 (NO in Step 403), a position in the screen 302 is set to be the projection position of the secondary information (Step 407). In other words, the layout is set such that the secondary information is displayed on the screen 302.

Note that the setting of a layout is not limited to the case of setting a layout in which all of the pieces of secondary information are displayed on the screen 302. For example, when a plurality of pieces of secondary information is projected, some of the pieces of secondary information are displayed on the region 340 outside of the screen 302, and the other pieces of secondary information are displayed on the screen 302. Such a layout may be set.

When the layout is set, the projector is controlled on the basis of the set layout (Step 406).

In the example illustrated in FIG. 15, the layout is set in Step 407 such that a channel number (“103”) and a channel name (“Movie”) are displayed near an upper portion of the screen 302. On the other hand, the layout is set such that a subtitle (“It's important”) of video content 351 is superimposed on the video content 351 to be displayed on the screen 302.

It may be determined, when the full-screen display mode is selected, whether it is possible to perform a full-screen display, as described above. When it is not possible to use the full-screen display mode, the projection position of the secondary information is set as appropriate. This makes it possible to display a high-quality image.

### Other Embodiments

The present technology is not limited to the embodiments described above, and can achieve various other embodiments.

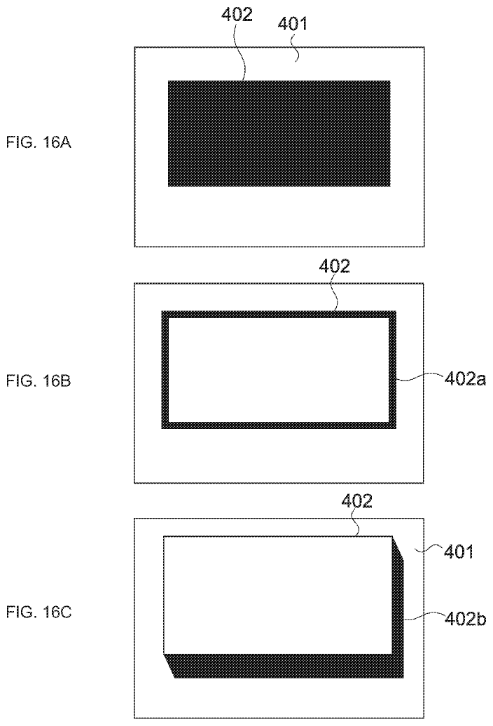

FIG. 16 is a schematic diagram for describing a specific example of detecting the position, the shape, and the size of the screen. The example in which an image of the screen is captured by the camera, and an image analysis technology or the like is used on the basis of the captured image to calculate screen information, has been described above. Here, a specific example of detecting the position and the like of the screen is described.

Note that, instead of, or in addition to the camera, another sensor such as an infrared sensor or a ranging sensor may be used as a detector that detects the position and the like of the screen. Further, detection information regarding the screen that is detected by the detector is not limited to a captured image, and results of detections performed by various sensors may be used.

For example, it is possible to detect the position, the shape, and the like of the screen by sensing an uneven surface facing the projection-target surface using an infrared sensor or the like. For example, the position, the shape, and the size of the uneven surface are detected as the position, the shape, and the size of the screen.

It is also possible to detect the position, the shape, and the size of a screen 402 by sensing a difference in color between a projection-target surface 401 and the screen 402, as illustrated in A of FIG. 16. Further, it is also possible to detect the position, the shape, and the size of the screen 402 by sensing a frame 402a surrounding the screen 402, as illustrated in B of FIG. 16.

Further, light is projected onto the projection-target surface 401 from the projector. It is also possible to detect the position, the shape, and the size of the screen 402 by sensing a shadow 402b of the screen 402 that is formed upon the projection of the light. Of course, it is also possible to combine the pieces of sensing described above.

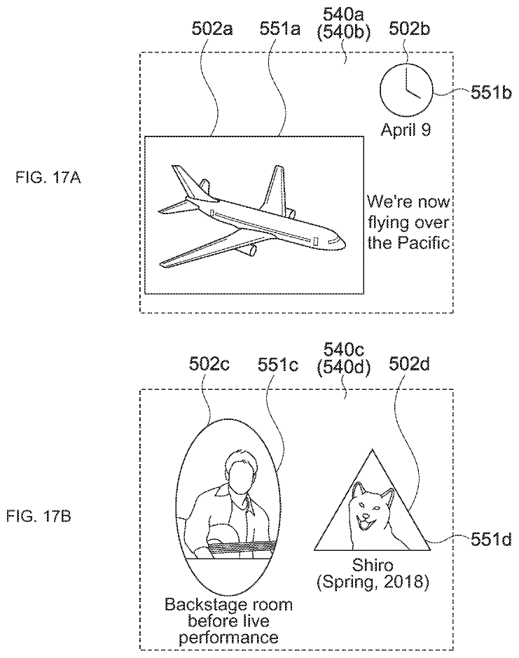

FIG. 17 schematically illustrates another example of the configuration of the screen. The number of screens arranged on the projection-target surface and the shape of the screen are not limited. For example, a rectangular screen 502a and a circular screen 502b are arranged in the example illustrated in A of FIG. 17.

Video content 551a is displayed on the screen 502a as primary information, and a subtitle (“We're now flying over the Pacific”) of the video content 551a is displayed on a region 540a outside of the screen 502a as secondary information.

Further, an image 551b of a clock is displayed on the screen 502b as primary information. A date is displayed on a region 540b outside of the screen 502b as secondary information. Note that the region 540b outside of the screen 502b can also be called the region 540a outside of the screen 502a.

As illustrated in A of FIG. 17, display of an image (the image of a clock) that fits the shape of the screen 502b makes it possible to provide a virtual environment in which it looks like an actual clock is arranged. It is also possible to provide a virtual environment in which it looks like a desired interior is arranged in a room, by setting, as appropriate, the shape of the screen and information to be displayed.

An elliptical screen 502c and a triangular screen 502d are arranged in the example illustrated in B of FIG. 17. Photographic content 551c is displayed on the screen 502c as primary information, and an explanatory text (“Backstage room before live performance”) of the photographic content 551c is displayed on a region 540c outside of the screen 502c as secondary information.

Further, photographic content 551d is displayed on the screen 502d as primary information, and an explanatory text (“Shiro (Spring, 2018)”) of the photographic content 551d is displayed on a region 540d outside of the screen 502d (that can also be called the outside region 540c) as secondary information.

A roll screen may be used. For example, the size and the like of an extended screen is detected as appropriate. Then, it is possible to perform switching between the normal display mode and the full-screen display mode as appropriate to apply the normal display mode or the full-screen display mode to the extended screen.

An object other than a screen may be used as a projection-target object. For example, a specified region, a specified surface, or the like of an object such as a painting or furniture may be used as a projection-target object.

There is a possibility that primary information will not be displayed on the screen in a largest size when the full-screen display mode is selected. Primary information may be displayed in a size different from the largest size, according to, for example, an instruction given by a user, the shape of a screen, the type of content, or details of the content. In this case, secondary information may be displayed on a blank region, for example, when there exists the blank region on the screen.

When the full-screen display mode is selected, projection of secondary information may be controlled according to a change in at least one of the position, the shape, or the size of primary information projected onto the screen. For example, it is assumed that there is a change in an aspect ratio of the video content 51 from the state illustrated in B of FIG. 7 in which the video content 51 is displayed on the entire screen 2 to the state illustrated in FIG. 8. In this case, the position, the shape, and the size of secondary information displayed on the region 40 outside of the screen 2 may be changed as appropriate. Alternatively, secondary information may be displayed on the blank region 41 of the screen 2.

The system control apparatus and the projector described above may be integrally configured. In other words, a function of the system control apparatus may be installed in the projector projecting the first information and the second information. In this case, the projector serves as an embodiment of the information processing apparatus according to the present technology.

The information processing method and the program according to the present technology can be performed not only in a computer system including a single computer, but also in a computer system in which a plurality of computers operates cooperatively. Note that, in the present disclosure, the system refers to a set of components (such as apparatuses and modules (parts)) and it does not matter whether all of the components are in a single housing. Thus, a plurality of apparatuses accommodated in separate housings and connected to one another through a network, and a single apparatus in which a plurality of modules is accommodated in a single housing are both the system.

The execution of the information processing method and the program according to the present technology by the computer system includes, for example, both a case in which the control of the projection of the first information and the projection of the second information, the performing switching between the first information and the second projection mode, the acquisition of target-object information, the detection of the presence or absence of a target object, and the like are executed by a single computer; and a case in which the respective processes are executed by different computers. Further, the execution of each process by a specified computer includes causing another computer to execute a portion of or all of the process and acquiring a result of it.

In other words, the information processing method and the program according to the present technology are also applicable to a configuration of cloud computing in which a plurality of apparatuses shares a single function and collaboratively processes the single function through a network.

The image display system, the system control apparatus, the layout of the first information and the second information, the flow of projection control in each projection mode, and the like described with reference to the respective figures are merely embodiments, and any modifications may be made thereto without departing from the spirit of the present technology. In other words, for example, any other configurations or algorithms for carrying out the present technology may be adopted.

In the present disclosure, expressions using “approximate/substantially” such as “approximate plate shape” and “substantially similar” respectively mean specified ranges (for example, a range of +/−10%) in concept, with expressions such as “complete plate shape” and “completely similar” being respectively used as references. Instead of these expressions, simple expressions such as “plate shape” and “similar” without “approximate/substantially” can also be used.

At least two of the features of the present technology described above can also be combined. In other words, various features described in the respective embodiments may be combined discretionarily regardless of the embodiments. Further, the various effects described above are not limitative but are merely illustrative, and other effects may be provided.

Note that the present technology may also take the following configurations.

(1) An information processing apparatus, including:

a projection controller that controls projection of first information and projection of second information that is classified as information of which a type is different from a type of the first information; and

a mode controller that is capable of performing switching between a first projection mode and a second projection mode, the first projection mode being a projection mode in which the first information and the second information are projected onto a projection-target object, the second projection mode being a projection mode in which the first information is projected onto the projection-target object, and the second information is projected onto a region outside of the projection-target object.

(2) The information processing apparatus according to (1), in which

when the second projection mode is selected, the projection controller causes the first information to be projected onto the projection-target object in a largest size corresponding to a size of the projection-target object.

(3) The information processing apparatus according to (2), in which

when the second projection mode is selected, the projection controller causes the second information to be projected onto a position situated within a specified distance from the projection-target object.

(4) The information processing apparatus according to (3), further including an acquisition section that acquires target-object information that includes a position of the projection-target object, in which

the projection controller controls the projection of the first information and the projection of the second information on the basis of the acquired target-object information.

(5) The information processing apparatus according to (4), in which

the target-object information includes a shape and a size of the projection-target object.

(6) The information processing apparatus according to (4) or (5), in which

the acquisition section acquires the target-object information on the basis of detection information regarding the projection-target object, the detection information being detected by a detection apparatus.

(7) The information processing apparatus according to any one of (4) to (6), in which

the acquisition section acquires the target-object information on the basis of setting information regarding the projection-target object, the setting information being set by a user.

(8) The information processing apparatus according to any one of (4) to (7), in which

the acquisition section acquires region information regarding a projection-available region that includes a region, in the projection-target object, onto which projection is performed, and

the projection controller controls the projection of the first information and the projection of the second information on the basis of the target-object information and the region information.

(9) The information processing apparatus according to (8), in which

the projection-target object is a screen that is arranged on a projection-target surface,

the screen is made of material that enables the screen to display thereon a projection image with a higher image quality when the projection image is projected onto the screen than when the projection image is projected onto the projection-target surface, and

when the second projection mode is selected, the projection controller performs control on the basis of the target-object information and the region information, such that the first information is projected onto the screen in a largest size corresponding to a size of the screen, and such that the second information is projected onto a region that is situated outside of the screen and included in the projection-available region.

(10) The information processing apparatus according to any one of (1) to (9), in which

the first information includes content information, and

the second information includes at least one of additional information related to the content information, menu information, notification information, or advertisement information.

(11) The information processing apparatus according to any one of (1) to (10), in which

when the second projection mode is selected, the projection controller is capable of controlling at least one of a position, a shape, or a size of the second information to be projected.

(12) The information processing apparatus according to any one of (4) to (11), in which

the target-object information includes information regarding a positional change, the information regarding a positional change indicating a change in a relative position of the projection-target object with respect to an image projection apparatus that projects the first information and the second information, and

the display controller controls the projection of the first information and the projection of the second information on the basis of the information regarding a positional change.

(13) The information processing apparatus according to (12), in which

when the second projection mode is selected, the display controller controls the projection of the first information and the projection of the second information on the basis of the information regarding a positional change such that the projection of the first information and the projection of the second information are respectively maintained, the projection of the first information being projection of the first information onto the projection-target object, the projection of the second information being projection of the second information onto the outside region.

(14) The information processing apparatus according to any one of (1) to (13), further including a detector that detects presence or absence of the projection-target object, in which

the mode controller selects the second projection mode when the projection-target object is detected.

(15) The information processing apparatus according to any one of (1) to (14), in which

when the second projection mode is selected, the projection controller determines whether the second information is projectable onto a blank region that is a region, in the projection-target object, onto which the first information is not projected, and the projection controller projects the second information onto the blank region when the second information is projectable onto the blank region.

(16) The information processing apparatus according to any one of (1) to (15), in which

when the second projection mode is selected, the projection controller determines whether the second information is projectable onto the region outside of the projection-target object, and the projection controller projects the second information onto the projection-target object when the second information is not projectable onto the outside region.

(17) The information processing apparatus according to any one of (1) to (16), in which

when the second projection mode is selected, the projection controller controls the projection of the second information according to a change in at least one of a position, a shape, or a size of the first information to be projected.

(18) The information processing apparatus according to any one of (1) to (17), in which

the projection controller controls the projection of the first information and the projection of the second information, the projection of the first information and the projection of the second information being performed by an image projection apparatus.

(19) An information processing method, including:

controlling, by a computer system, projection of first information and projection of second information that is classified as information of which a type is different from a type of the first information; and

performing, by the computer system, switching between a first projection mode and a second projection mode, the first projection mode being a projection mode in which the first information and the second information are projected onto a projection-target object, the second projection mode being a projection mode in which the first information is projected onto the projection-target object, and the second information is projected onto a region outside of the projection-target object.

[20] A program that causes a computer system to perform a process including:

controlling projection of first information and projection of second information that is classified as information of which a type is different from a type of the first information; and performing switching between a first projection mode and a second projection mode, the first projection mode being a projection mode in which the first information and the second information are projected onto a projection-target object, the second projection mode being a projection mode in which the first information is projected onto the projection-target object, and the second information is projected onto a region outside of the projection-target object.

### REFERENCE SIGNS LIST

1, 401 projection-target surface
2, 202, 302, 402, 502a to 502d screen
(10a, 10b) projector
11, 311 projection-available region
20 camera
30 system control apparatus
31 image analyzer
32 input reception section
33 image information acquisition section
34 mode controller
35 projector controller
36 system optimization processor
40, 240, 340, 540a to 540d outside region
41, 241 blank region
51, 251, 351, 551a video content
52a, 52b calendar
53a, 53, 551c, 551d photographic content
100 image display system
551b image of clock

1. An information processing apparatus, comprising:
a projection controller that controls projection of first information and projection of second information that is classified as information of which a type is different from a type of the first information; and
a mode controller that is capable of performing switching between a first projection mode and a second projection mode, the first projection mode being a projection mode in which the first information and the second information are projected onto a projection-target object, the second projection mode being a projection mode in which the first information is projected onto the projection-target object, and the second information is projected onto a region outside of the projection-target object.

2. The information processing apparatus according to claim 1, wherein
when the second projection mode is selected, the projection controller causes the first information to be projected onto the projection-target object in a largest size corresponding to a size of the projection-target object.

3. The information processing apparatus according to claim 2, wherein
when the second projection mode is selected, the projection controller causes the second information to be projected onto a position situated within a specified distance from the projection-target object.

4. The information processing apparatus according to claim 3, further comprising an acquisition section that acquires target-object information that includes a position of the projection-target object, wherein
the projection controller controls the projection of the first information and the projection of the second information on a basis of the acquired target-object information.

5. The information processing apparatus according to claim 4, wherein
the target-object information includes a shape and a size of the projection-target object.

6. The information processing apparatus according to claim 4, wherein
the acquisition section acquires the target-object information on a basis of detection information regarding the projection-target object, the detection information being detected by a detection apparatus.

7. The information processing apparatus according to claim 4, wherein
the acquisition section acquires the target-object information on a basis of setting information regarding the projection-target object, the setting information being set by a user.

8. The information processing apparatus according to claim 4, wherein
the acquisition section acquires region information regarding a projection-available region that includes a region, in the projection-target object, onto which projection is performed, and
the projection controller controls the projection of the first information and the projection of the second information on a basis of the target-object information and the region information.

9. The information processing apparatus according to claim 8, wherein
the projection-target object is a screen that is arranged on a projection-target surface,
the screen is made of material that enables the screen to display thereon a projection image with a higher image quality when the projection image is projected onto the screen than when the projection image is projected onto the projection-target surface, and
when the second projection mode is selected, the projection controller performs control on the basis of the target-object information and the region information, such that the first information is projected onto the screen in a largest size corresponding to a size of the screen, and such that the second information is projected onto a region that is situated outside of the screen and included in the projection-available region.

10. The information processing apparatus according to claim 1, wherein
the first information includes content information, and
the second information includes at least one of additional information related to the content information, menu information, notification information, or advertisement information.

11. The information processing apparatus according to claim 1, wherein
when the second projection mode is selected, the projection controller is capable of controlling at least one of a position, a shape, or a size of the second information to be projected.

12. The information processing apparatus according to claim 4, wherein
the target-object information includes information regarding a positional change, the information regarding a positional change indicating a change in a relative position of the projection-target object with respect to an image projection apparatus that projects the first information and the second information, and
the display controller controls the projection of the first information and the projection of the second information on a basis of the information regarding a positional change.

13. The information processing apparatus according to claim 12, wherein
when the second projection mode is selected, the display controller controls the projection of the first information and the projection of the second information on the basis of the information regarding a positional change such that the projection of the first information and the projection of the second information are respectively maintained, the projection of the first information being projection of the first information onto the projection-target object, the projection of the second information being projection of the second information onto the outside region.

14. The information processing apparatus according to claim 1, further comprising a detector that detects presence or absence of the projection-target object, wherein
the mode controller selects the second projection mode when the projection-target object is detected.

15. The information processing apparatus according to claim 1, wherein
when the second projection mode is selected, the projection controller determines whether the second information is projectable onto a blank region that is a region, in the projection-target object, onto which the first information is not projected, and the projection controller projects the second information onto the blank region when the second information is projectable onto the blank region.

16. The information processing apparatus according to claim 1, wherein
when the second projection mode is selected, the projection controller determines whether the second information is projectable onto the region outside of the projection-target object, and the projection controller projects the second information onto the projection-target object when the second information is not projectable onto the outside region.

17. The information processing apparatus according to claim 1, wherein
when the second projection mode is selected, the projection controller controls the projection of the second information according to a change in at least one of a position, a shape, or a size of the first information to be projected.

18. The information processing apparatus according to claim 1, wherein
the projection controller controls the projection of the first information and the projection of the second information, the projection of the first information and the projection of the second information being performed by an image projection apparatus.

19. An information processing method, comprising:
controlling, by a computer system, projection of first information and projection of second information that is classified as information of which a type is different from a type of the first information; and
performing, by the computer system, switching between a first projection mode and a second projection mode, the first projection mode being a projection mode in which the first information and the second information are projected onto a projection-target object, the second projection mode being a projection mode in which the first information is projected onto the projection-target object, and the second information is projected onto a region outside of the projection-target object.

20. A program that causes a computer system to perform a process comprising:
controlling projection of first information and projection of second information that is classified as information of which a type is different from a type of the first information; and
performing switching between a first projection mode and a second projection mode, the first projection mode being a projection mode in which the first information and the second information are projected onto a projection-target object, the second projection mode being a projection mode in which the first information is projected onto the projection-target object, and the second information is projected onto a region outside of the projection-target object.
